(19) United States
(12) Patent Application Publication
(10) Pub. No.: US 2024/0020593 A1
(43) Pub. Date: Jan. 18, 2024

(54) USER INTERFACE PRESENTING INTEGRATED ENTERPRISE SERVICES

(71) Applicant: Microsoft Technology Licensing, LLC, Redmond, WA (US)

(72) Inventors: Faisal NASIR, Redmond, WA (US); Michael Stephen HOLLYWOOD, Newry (IE); Menaga RAGHU, Bellevue, WA (US); Pallavi PALLAE, Hyderabad (IN)

(21) Appl. No.: 17/812,170

(22) Filed: Jul. 12, 2022

(51) Int. Cl. G06Q 10/06

(52) U.S. Cl. CPC G06Q 10/06311

(57) ABSTRACT

Systems and methods provide an improved user interface that presents integrated enterprise services. The method includes generating a persona associated with a user based on the user's role and tasks typically performed by the user, generating insights for the generated persona, and pushing the generated insights to a centralized user interface. The centralized user interface enables the insights, such as action items for review, updates, and so forth, to be addressed in a native version of an application provided by the enterprise services.

### BACKGROUND

Enterprise environments, such as enterprise engineering environments, are changing rapidly due to increased customer expectations, technology competition, and the need to support hybrid work and future of work scenarios. Many employees utilize a growing suite of disparate applications to perform work-related tasks including communication applications, video call applications, and file storage applications, as well as more specialized applications depending on the employee's specific role. However, the quantity of applications being used at any one time can lead to challenges due to a lack of a cohesive, integrated employee experience.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Examples and implementations disclosed herein are directed to systems and methods that provide an improved user interface that presents integrated enterprise services. The computer-implemented method includes identifying a role of a user and at least one task performed by the user, generating a persona associated with the user based at least in part on the identified role of the user and the identified at least one task performed by the user, generating an insight for the generated persona, pushing the generated insight to a user interface, and presenting the user interface including the pushed insight.

### BRIEF DESCRIPTION OF THE DRAWINGS

The present description will be better understood from the following detailed description read in light of the accompanying drawings, wherein:

FIG. 1 is a block diagram illustrating an example computing device for implementing various examples of the present disclosure;

FIG. 2 is a block diagram illustrating an example system for implementing various examples of the present disclosure;

FIG. 3 is a flow chart illustrating a computer-implemented method of generating a persona according to various examples of the present disclosure;

FIG. 4 is a flow chart illustrating a computer-implemented method of generating insights according to various examples of the present disclosure;

FIG. 5 illustrates an example user interface implementing various examples of the present disclosure;

FIG. 6 illustrates an example productivity experience extension according to various examples of the present disclosure; and

FIG. 7 is a flow chart illustrating a computer-implemented method of presenting integrated enterprise services on a user interface refreshing according to various examples of the present disclosure.

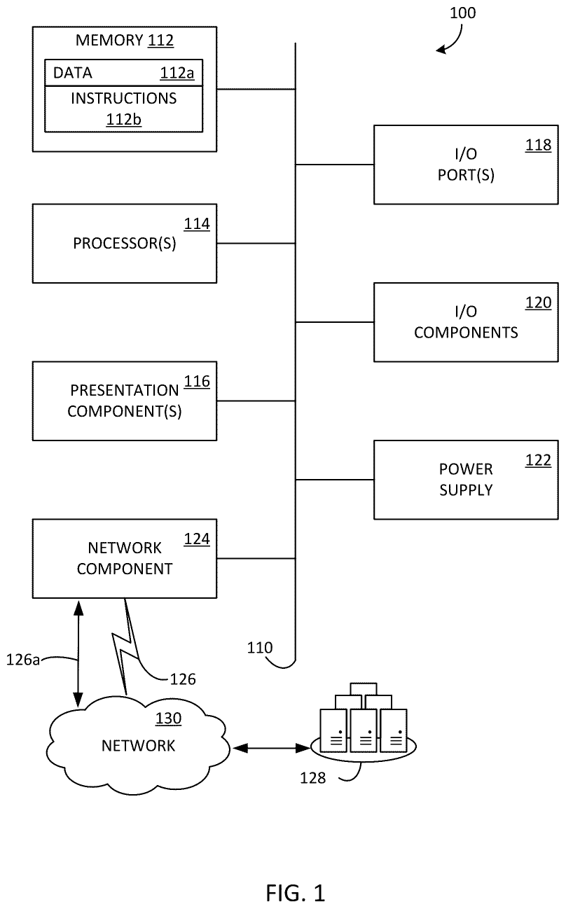

Corresponding reference characters indicate corresponding parts throughout the drawings. In FIGS. 1 to 7, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As described herein, enterprise environments are increasingly being utilized in remote and semi-remote environments. Enterprise environments may include an infrastructure that includes a growing suite of disparate applications for performing work-related tasks, including communication applications, video conferencing tools and applications, and file storage tools and applications, as well as specialized applications depending on an employee's particular role. For example, the suite of an engineer may include one or more developer applications to write and edit software code and engineering tools and file storage tools, the suite of a graphic designer may include one or more video or image editing applications, the suite of an accountant may include accounting or other financial software, and so forth.

However, the combination of multiple disparate applications may present challenges. For example, enterprise environments including a wide variety of applications may not be presented in a cohesive interface. This may lead to challenges in communication between employees and a user experience that is less than desirable. For example, many different applications may be required to execute different portions of a task for the task to be completed. For example, a software engineer may have a task to write code. To complete this task, the engineer writes the code in a code development application, sends the file containing the code to a supervisor in an electronic mail (e-mail) application, and conducts a video call with the supervisor to discuss the code in a video call application, where the code may or may not be available for viewing to each party during the call. In addition, for a manager who oversees employees, combination of disparate applications may make it difficult to manage and deliver on customer expectations, employee productivity, and provide data-driven leadership.

Accordingly, the present application provides an integrated enterprise service that links and natively integrates systems into a single environment. The environment may include native integrated application experiences from different applications and/or applications systems, machine learning (ML) or analytics-based insights based on an individual persona for the user, learning experiences based on the persona, and different topics based on the persona that may impact the user's work. The native integrated application experiences enable different applications to be accessed directly from the environment without navigating the external application. The ML or analytics-based insights may push tasks and notifications in order to keep up with a list of tasks to be completed, track the status and progress of different tasks, and so forth directly in the native integrated application experience. Thus, a single environment enabled by the present disclosure provides an improved user interface that increases productivity by presenting integrated enterprise services.

FIG. 1 is a block diagram illustrating an example computing device 100 for implementing aspects disclosed herein and is designated generally as computing device 100. Computing device 100 is but one example of a suitable computing environment and is not intended to suggest any limitation as to the scope of use or functionality of the examples disclosed herein. Neither should the computing device 100 be interpreted as having any dependency or requirement relating to any one or combination of components/modules illustrated.

The examples disclosed herein may be described in the general context of computer code or machine- or computer-executable instructions, such as program components, being executed by a computer or other machine. Program components include routines, programs, objects, components, data structures, and the like that refer to code, performs particular tasks, or implement particular abstract data types. The disclosed examples may be practiced in a variety of system configurations, including servers, personal computers, laptops, smart phones, servers, virtual machines (VMs), mobile tablets, hand-held devices, consumer electronics, specialty computing devices, etc. The disclosed examples may also be practiced in distributed computing environments when tasks are performed by remote-processing devices that are linked through a communications network.

The computing device 100 includes a bus 110 that directly or indirectly couples the following devices: computer-storage memory 112, one or more processors 114, one or more presentation components 116, I/O ports 118, I/O components 120, a power supply 122, and a network component 124. While the computing device 100 is depicted as a seemingly single device, multiple computing devices 100 may work together and share the depicted device resources. For example, memory 112 is distributed across multiple devices, and processor(s) 114 is housed with different devices. Bus 110 represents what may be one or more busses (such as an address bus, data bus, or a combination thereof). Although the various blocks of FIG. 1 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 1 and the references herein to a “computing device.”

Memory 112 may take the form of the computer-storage memory device referenced below and operatively provide storage of computer-readable instructions, data structures, program modules and other data for the computing device 100. In some examples, memory 112 stores one or more of an operating system (OS), a universal application platform, or other program modules and program data. Memory 112 is thus able to store and access data 112a and instructions 112b that are executable by processor 114 and configured to carry out the various operations disclosed herein. In some examples, memory 112 stores executable computer instructions for an OS and various software applications. The OS may be any OS designed to the control the functionality of the computing device 100, including, for example but without limitation: WINDOWS® developed by the MICROSOFT CORPORATION®, MAC OS® developed by APPLE, INC.® of Cupertino, Calif, ANDROID™ developed by GOOGLE, INC.® of Mountain View, California, open-source LINUX®, and the like.

By way of example and not limitation, computer readable media comprise computer-storage memory devices and communication media. Computer-storage memory devices may include volatile, nonvolatile, removable, non-removable, or other memory implemented in any method or technology for storage of information such as computer-readable instructions, data structures, program modules, or the like. Computer-storage memory devices are tangible and mutually exclusive to communication media. Computer-storage memory devices are implemented in hardware and exclude carrier waves and propagated signals. Computer-storage memory devices for purposes of this disclosure are not signals per se. Example computer-storage memory devices include hard disks, flash drives, solid state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number an organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device, CPU, GPU, ASIC, system on chip (SoC), or the like for provisioning new VMs when configured to execute the instructions described herein.

Processor(s) 114 may include any quantity of processing units that read data from various entities, such as memory 112 or I/O components 120. Specifically, processor(s) 114 are programmed to execute computer-executable instructions for implementing aspects of the disclosure. The instructions may be performed by the processor 114, by multiple processors 114 within the computing device 100, or by a processor external to the client computing device 100. In some examples, the processor(s) 114 are programmed to execute instructions such as those illustrated in the flow charts discussed below and depicted in the accompanying figures. Moreover, in some examples, the processor(s) 114 represent an implementation of analog techniques to perform the operations described herein. For example, the operations are performed by an analog client computing device 100 and/or a digital client computing device 100.

Presentation component(s) 116 present data indications to a user or other device. Example presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 100, across a wired connection, or in other ways. I/O ports 118 allow computing device 100 to be logically coupled to other devices including I/O components 120, some of which may be built in. Example I/O components 120 include, for example but without limitation, a microphone, joystick, game pad, satellite dish, scanner, printer, wireless device, etc.

The computing device 100 may communicate over a network 130 via network component 124 using logical connections to one or more remote computers. In some examples, the network component 124 includes a network interface card and/or computer-executable instructions (e.g., a driver) for operating the network interface card. Communication between the computing device 100 and other devices may occur using any protocol or mechanism over any wired or wireless connection. In some examples, network component 124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 124 communicates over wireless communication link 126 and/or a wired communication link 126a across network 130 to a cloud environment 128. Various different examples of communication links 126 and 126a include a wireless connection, a wired connection, and/or a dedicated link, and in some examples, at least a portion is routed through the Internet.

The network 130 may include any computer network or combination thereof. Examples of computer networks configurable to operate as network 130 include, without limitation, a wireless network; landline; cable line; digital subscriber line (DSL): fiber-optic line; cellular network (e.g., 3G, 4G, 5G, etc.); local area network (LAN); wide area network (WAN); metropolitan area network (MAN); or the like. The network 130 is not limited, however, to connections coupling separate computer units. Rather, the network 130 may also include subsystems that transfer data between servers or computing devices. For example, the network 130 may also include a point-to-point connection, the Internet, an Ethernet, an electrical bus, a neural network, or other internal system. Such networking architectures are well known and need not be discussed at depth herein.

As described herein, the computing device 100 may be implemented as one or more servers. The computing device 100 may be implemented as a system 200 or in the system 200 as described in greater detail below.

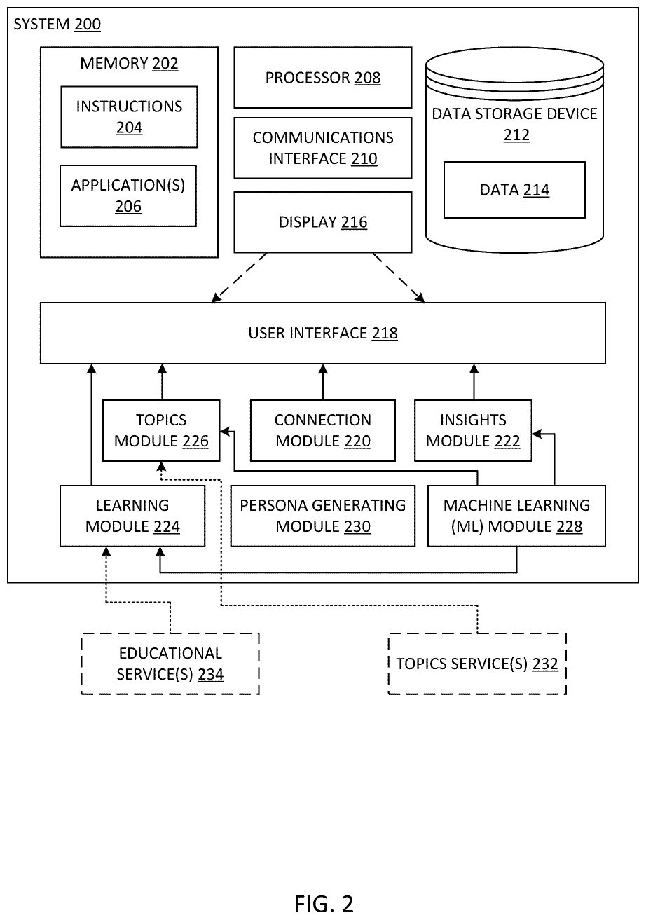

FIG. 2 is a block diagram illustrating an example system for implementing various examples of the present disclosure. The system 200 may include the computing device 100. In some implementations, the system 200 includes a cloud-implemented server that includes each of the components of the system 200 described herein. In some implementations, the system 200 is presented as a single computing device that contains each of the components of the system 200. For example, the system 200 may include a laptop computer containing each of the components described herein. In other implementations, the system 200 includes multiple devices. For example, the system 200 may include a computer connected to one or more monitors utilized as the display 216.

The system 200 includes a memory 202, a processor 208, a communications interface 210, a data storage device 212, a display 216, and a user interface 218. The memory 202 stores instructions 204 executed by the processor 208 to control the communications interface 210, the display 216, and the user interface 218. The memory 202 further stores data, such as one or more applications 206.

An application 206 is a program designed to carry out a specific task on the system 200. For example, the applications 206 may include, but are not limited to, drawing applications, paint applications, web browser applications, messaging applications, navigation/mapping applications, word processing applications, gaming applications, video applications, an application store, applications included in a suite of productivity applications such as calendar applications, instant messaging applications, document storage applications, video and/or audio call applications, and so forth, and specialized applications for a particular system 200. A specialized application is an application 206 that is used by a particular type of user. Examples of specialized applications may include, but are not limited to, developer applications to write and edit software code, video or image editing applications, accounting or other financial applications, legal applications for legal research and billing, and so forth. The applications 206 may communicate with counterpart applications or services, such as web services. In an example, the applications 206 represent downloaded client-side applications that correspond to server-side services executing in a cloud.

The processor 208 executes the instructions 204 stored on the memory 202 to execute various functions of the system 200. For example, the processor 208 controls the communications interface 210 to transmit and receive various signals and data, controls the data storage device 212 to store data 214, controls the user interface 218 to display one or more client-side versions of the applications 206 on the display 216, and so forth. In some implementations, the system 200 includes one or more specialized modules that are implemented on the processor 208 to perform specialized functions. For example, the system 200 may include a connections module 220, an insights module 222, a learning module 224, a topics module 226, a machine learning (ML) module 228, and a persona developing module 230.

The connection module 220 is a specialized processor implemented on the processor 208 that pushes a native integrated application experience from one or more applications 206 to the user interface 218. For example, the connection module 220 integrates a native version of first- and third-party applications 206 to the user interface 218. By integrating the applications 206 with the user interface 218 and presenting the integrated applications 206 as part of a consistent user interface 218, localized versions of the applications 206, some of which may be third-party applications, may be accessed and executed through the user interface 218 without navigating away from the centralized environment provided by the user interface 218.

The persona is generated by the persona generating module 230. The persona generating module 230 is a specialized processor implemented on the processor 208 that generates a persona for a particular user. The persona may be generated using the ML module 228 and include the type of role the user has within their respective organization, the type of work the user performs, and so forth. For example, within an engineering enterprise environment, the role may be a junior engineer, a senior engineer, a project manager, and so forth, and the type of work may include application or product development, application or product review, management, and so forth. In some examples, the type of work may be determined to be more specific. For example, the type of work may be product development for a specific type of product or group of products. Thus, a persona may include a junior engineer whose day-to-day tasks include developing code for a particular application. In another example, the persona may include a senior product manager whose day-to-day tasks include reviewing developed code, reviewing test results, and preparing reports for a particular product as it prepares to launch.

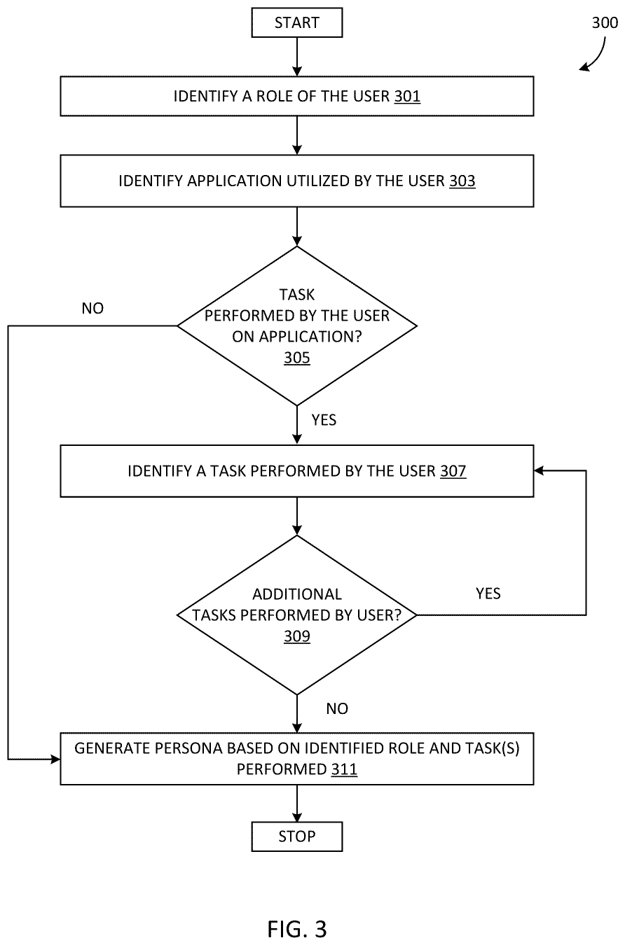

FIG. 3 is a flow chart illustrating a computer-implemented method of generating a persona according to various examples of the present disclosure. The operations illustrated in FIG. 3 are for illustration and should not be construed as limiting. Various examples of the operations may be used without departing from the scope of the present disclosure. The operations of the flow chart 300 may be executed by one or more components of the system 200, including the processor 208, the connection module 220, the persona generating module 230, and/or the ML module 228.

The flow chart 300 begins by the persona generating module 230 identifying a role of a user in operation 301. The role of a user may include one or both of a title of the user, such as a software engineer, project manager, associate, consultant, and so forth, and an experience level of the user, such as junior, senior, and so forth. The role may be a combination of the title and the experience level. For example, a role for a particular user may be identified as a junior software engineer, a senior project manager, and so forth. In other examples, the role may be identified only the title, such as associate or consultant. However, it should be understood that these examples are presented for illustration only and should not be construed as limiting. Various examples of roles may be used without departing from the scope of the present disclosure. In some examples, the title and experience level may be identified by extracting the role and experience level information form an organizational database stored as data 214 in the data storage device 212 or an external database. For example, the data 214 may include a graph that illustrates team memberships, product and service relationships such as services owned, and productivity and systems assignments related to each user in the organization. Upon generation of the persona, as described below, the data in the graph may be associated with the generated persona. The data is collected and stored to present relevant, performant, and responsive experiences to users of the system to enhance productivity, as described herein.

In operation 303, one or more applications 206 that is utilized by the user is identified. In some examples, the persona generating module 230 identifies the application(s) 206 by pulling data usage information of one or more electronic devices associated with the user. In another example, the persona generating module 230 identifies the application 206 by identifying the native versions of applications 206 that have been integrated to the user interface 218 by the connections module 220. In operation 305, the persona generating module 230 determines whether at least one task has been performed by the user using the identified application(s) 206. In some examples, the persona generating module 230 implements the ML module 228 to retrieve the usage data of the identified application(s) 206 to determine whether at least one task has been performed by the user using the identified application(s) 206. For example, the ML module 228 may identify whether at least one task has been performed by monitoring the graph that illustrates team memberships, product and service relationships such as services owned, and productivity and systems assignments for a particular user or persona. The graph may be updated upon the completion of each task, for example to update a status of a task from incomplete or pending to completed. Upon identification of the change in status of the task to completed, the ML module 228 determines that the task has been performed by the user.

In examples where no tasks are identified in operation 305, the flow chart 300 proceeds to operation 313, described below. In examples where at least one task has been performed, the persona generating module 230 identifies the at least one task performed by the user in operation 307. For example, the ML module 228 may provide, as an output to the persona generating module 230, an identification of each the identified task. The identification may include the type of task performed, details regarding the action the user took to perform the task, time stamps identifying when the user performed the task, and so forth.

In operation 309, the persona generating module 230 determines whether an additional task was performed by the user. In other words, the persona generating module 230 determines whether a task, other than the task identified in operation 307, has been performed but not yet identified. Where an additional task has been identified, the persona generating module 230 returns to operation 307 and identifies the additional tasks. Where additional tasks are not identified, i.e., each task performed has been identified, the persona generating module 230 generates the persona based on the identified role and tasks(s) performed by the user in operation 311.

In operation 311, the persona generating module 230 generates the persona. In one example, as described herein, a persona may be a junior engineer whose day-to-day tasks include developing code for a particular application. In this example, the role of the persona is generated as identified in operation 301 and the day-to-day tasks are extracted from the identified tasks performed by the user in particular applications in operation 307. In another example, a persona may be a senior product manager whose day-to-day tasks include reviewing developed code, reviewing test results, and preparing reports for a particular product as it prepares to launch. In this example, the role of the persona is generated as identified in operation 301 and the day-to-day tasks are extracted from the identified tasks performed by the user in particular applications in operation 307.

The insights module 222 is a specialized processor implemented on the processor 208 that integrates ML and/or analytics based insights for a particular persona and pushes the insights on the user interface 218. As referenced herein, an insight is a notification identifying an action item, an update, a suggested action, or any other notification assigned to the user associated with the particular persona. The insight may be presented as a card on a home page, a popup on a home page, or any other type of notification on the user interface 218. In examples where the system 200 is an engineering enterprise system, the insights may include, but are not limited to, one or more of actions assigned for an incident workflow, actions for incident repair items, actions for postmortem analysis for a resolved incident, updates to stories assigned to the user, action items linked to an active or new task, an update to transmitted requests, received requests, action items for compliance, and so forth.

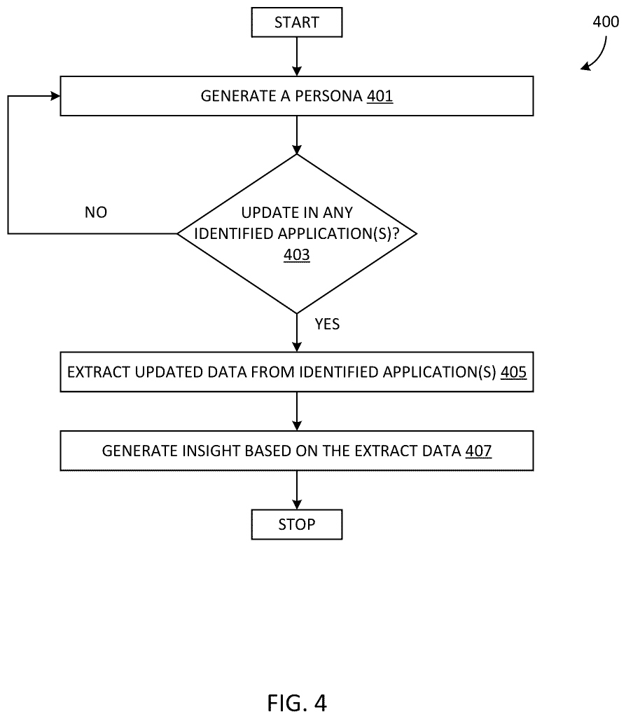

FIG. 4 is a flow chart illustrating a computer-implemented method of generating insights according to various examples of the present disclosure. The operations illustrated in FIG. 4 are for illustration and should not be construed as limiting. Various examples of the operations may be used without departing from the scope of the present disclosure. The operations of the flow chart 400 may be executed by one or more components of the system 200, including the processor 208, the insights module 222, the connection module 220, the ML module 228, and/or the persona generating module 230.

The flow chart 400 begins by the persona generating module 230 generating a persona in operation 401. The persona may be generated as described herein, such as in the description of FIG. 3. In operation 403, the insights module 222 identifies whether any identified applications 206 have an update to present to the user. An update may be specific to the particular identified application 206. For example, where the identified application is an email application, an update may be a newly received email that is unread and/or has not been responded to, a newly received calendar invitation that is unread and/or has not been responded to, a reminder to send a new email or respond to a previously received email, and so forth. As another example, where the identified application is an application used to prepare software code, an update may be a task to draft new software code, a notification that previously drafted code has been reviewed by another user, a notification that previously drafted code has been edited or modified by another user, a notification that previously drafted code was copied for inclusion in another project or aspect of another project, and so forth. Where an update is not detected, the flow chart 400 returns to operation 401. In some implementations, the insights module 222 continuously executes operation 403 to monitor for updates to identified applications. Where an update is detected, the flow chart 400 proceeds to operation 405.

In operation 405, the insights module 222 extracts updated data from the identified application(s) 206. The updated data is data that is updated based on the update identified in operation 403. For example, where the update is a notification that previously drafted code has been edited or modified by another user, the updated data may include the newly edited code and/or the revisions to the original code.

In operation 407, the insights module 222 generates an insight based on the extracted data. The insight is a notification that presents the update in the identified application 206 on the user interface 218 to the user and enables the notification to be accessed directly from the insight. For example, where the update is a notification that previously drafted code has been edited or modified by another user and the updated data may include the newly edited code and/or the revisions to the original code, the insight presents a summary of the update and provides a mechanism to review the newly edited code and/or the revisions to the original code in the native version of the application 206 in which the update was identified. As described herein, the native integrated application 206 is pushed to the user interface 218 by the connection module 220. Accordingly, the connection module 220 not only provides the native integrated application 206 to the user interface 218 but also enables the native integrated application 206 to be accessed directly via an insight generated by the insights module 222. Accordingly, by pushing insights to the user interface 218 and enabling the insights to be addressed directly from a native version of the associated application 206 rather than an external version or external system entirely, the present disclosure provides an improved and integrated enterprise service that facilitates connectivity and productivity within an organization from a centralized hub.

In some implementations, the ML module 228 is further implemented to assist in generating the insights. The ML module 228 may be implemented on the processor 208 and executes one or more ML algorithms based on various enterprise data to help generate the insights. The enterprise data may include rules and metadata from a particular system. For example, where the system 200 is an engineering enterprise system, the rules may include a particular time period to complete a task, tasks that are automatically added or modified based on the completion of another task, and so forth. In some examples, the enterprise data is stored as one example of the data 214 in the data storage device 212. The ML module 228 may receive, as input, data including, but not limited to, the type of work a user has historically or recently performed, upcoming tasks that have been assigned to the user, and data extracted from integrated applications 206 such as email applications, calendar applications, and specialized applications, and so forth and output recommended insights to be selected and pushed to the user interface 218 by the insights module 222. For example, based on the results provided the ML module 228, the insights module 222 may push productivity insights to the user interface 218. The productivity insights may include, but are not limited to, reviewed code, which has been reviewed by a supervisor or colleague and has comments ready for review, action items to take, incident tasks to be opened and resolved, compliance tasks to be opened and resolved, and so forth.

In some examples, the ML module 228 may analyze data for more than one persona simultaneously because the data may be related to more than one persona. For example, a first persona may include a junior software engineer, who has an open task pushed in the insights module 222 to draft code for a particular aspect of an application, and a second persona may include a senior software engineer. Upon the completion of the open task to draft the code for the aspect of the application, the junior software engineer's open task may be closed, i.e., marked as complete, and a new task is pushed by the insights module 222 for the second persona to review the drafted code completed by the first persona. The insights module 222 for the second persona may specify a time frame during which the new open task for the second persona is to be completed based on enterprise data for the system 200.

The learning module 224 is a specialized processor implemented on the processor 208 that pushes content related to the insights and the persona to the user interface 218. In some examples, the ML module 228 provides recommendations for content for the particular persona to the learning module 224 based on one or more of the enterprise data, the type of work a user has historically or recently performed, upcoming tasks that have been assigned to the user, and data extracted from integrated applications 206 such as email applications, calendar applications, and specialized applications, and so forth. Based on the provided recommendations, the learning module 224 may identify learning-based content, including but not limited to one or more educational service(s) 234, extract the identified educational service(s) 234, and push the extracted educational service(s) 234 to the user interface 218. In other examples, the ML module 228 may extract the recommended educational service(s) 234 and provide the educational service(s) 234 to the learning module 224 to be pushed to the user interface 218.

In another example, the learning module 224 identifies a theme associated with the role identified by the persona generating module 230, the at least one task performed by the user and identified by the persona generating module 230, and an application accessed to perform the at least one task. The theme may be broad, such as engineering, code development, code reviewing, project management, leadership, a particular industry, compliance, and so forth, or more narrow, such as a particular coding language, particular types of projects, and so forth. The learning module 224 identifies metadata associated with the theme. The metadata may include, but is not limited to, role classification, a user's experience in the role, task(s) assigned to the user, classification of a task, complexity of a task, rate of completion of the task across people in the same role, any data available for direct learning resources used to complete the task, and so forth. The metadata may be cross-referenced to identify learning-based content associated with the theme. The learning module 224 then presenting the learning-based content associated with the theme on the user interface 218. Accordingly, the learning module 224 provides resources on the user interface 218 that may be utilized by a user to continually improve their skills and knowledge as well as improve the relevance, ordering, and search optimization capabilities in the learning module 224 for each persona and roles.

In some examples, the metadata further includes a priority for each task and insight presented on the user interface 218. The priority may be received from an external device, such as after being set by a supervisor, or be manually determined by a user. The priorities may order the insights and the detailed information and actions available in the connection module 220, insights module 222, learning module 224, and topics module 226 described herein.

The educational services 234 may include, but are not limited to, articles, books, handbooks, instruction manuals, video content, courses, and so forth. In some examples, the educational services 234 pushed to the user interface 218 by the learning module 224 are suggested material to assist the user based on the persona generated by the persona generating module 230. For example, where the generated persona is a junior software engineer with recent and/or upcoming tasks to write code in a particular programming language, the educational services 234 pushed to the user interface 218 by the learning module 224 may include guides, handbooks, and video tutorials that contain tips and best practices for writing code in the particular language. In examples where the generated persona is a project manager with recent and/or upcoming tasks to review a prototype of an application before presenting the prototype to a product manager, the educational services 234 pushed to the user interface 218 by the learning module 224 may include overviews of similar applications that have recently been released, presentation tips, and leadership tools.

The topics module 226 is a specialized processor implemented on the processor 208 that provides content regarding one or more topics. The topics module 226 extracts topics from a topics service 232 and pushes the topics to the user interface 218. In some examples, the topics may be topics that are being discussed or presented throughout the system 200 to different users that may also impact the particular persona. For example, the topics may be selected from the enterprise system 200, from websites the user frequently visits for work-related tasks, electronic communications within the organization, and so forth. In some implementations, the ML module 228 provides recommendations for topics for the particular persona to the topics module 226 based on one or more of the enterprise data, the type of work a user has historically or recently performed, upcoming tasks that have been assigned to the user, and data extracted from integrated applications 206 such as email applications, calendar applications, and specialized applications, and so forth.

In some examples, the topics module 226 identifies a topic that is associated with one or more of the role identified by the persona generating module 230, the at least one task performed by the user and identified by the persona generating module 230, an application accessed to perform the at least one task, any teams in the organization the user is associated with, and additional users in an organization of the user. The topics module 226 identifies content associated with the identified topic and then presents the identified content on the user interface 218. Accordingly, the topics module 226 provides resources on the user interface 218 related to information within the organization that may impact the user's role and/or the task(s) the user performs. By pushing the resources to the user interface 218 directly, a relevant and usable list of topics may be presented to a user while reducing the time typically required to discover categories and a granular level of information needed for various phases of projects or for collaboration with others.

The data storage device 212 stores data 214. The data 214 may include any data, including, but not limited to, data related to the applications 206 executing on the user interface 218, enterprise data for the system 200, data related to one or more personas generated by the persona generating module 230, and so forth. In some examples, the data 214 includes a library of content and resources from which the learning-based content presented by the learning module 224 is selected. In some examples, the data 214 includes a library of content from which the content presented by the topics module 226 is selected.

The display 216 presents the user interface 218. In some examples, the user interface 218 may be presented on one display 216. In other examples, the user interface 218 may be presented on more than one display 216. Each display 216 may be a monitor that includes an in plane switching (IPS) liquid-crystal display (LCD), an LCD without IPS, an organic light-emitting diode (OLED) screen, or any other suitable type of display. In some implementations, the display 216 includes a touch screen such that the user interface 218 may directly receive an input, such as from a stylus or from the finger of a user of the system 200. The display 216 supports various interactions, such as panning, scrolling, zooming in, zooming out, inking, and so forth.

In some examples, the system 200 is a mobile electronic device and the display 216 is the display of the mobile electronic device. Thus, the user interface 218 is presented as a mobile interface. In this example, the native integrated application(s) 206 are mobile versions of the first- or third-party application(s) 206.

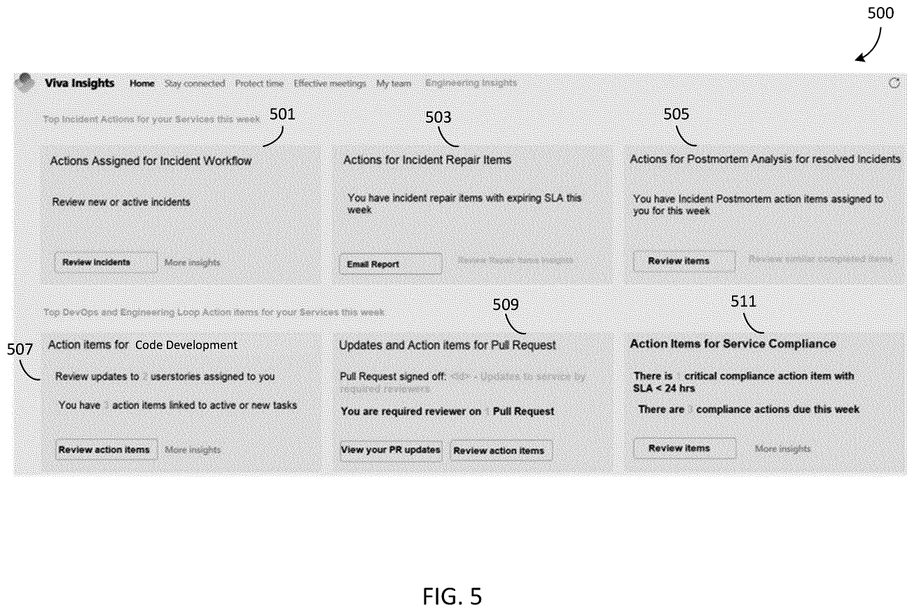

FIG. 5 illustrates an example user interface implementing various examples of the present disclosure. The user interface 500 illustrated in FIG. 5 is presented for illustration only and should not be construed as limiting. Various examples of the user interface 500 may be implemented without departing from the scope of the present disclosure. The user interface 500 may be an example of the user interface 218 described herein.

The user interface 500 illustrates a plurality of insights 501, 503, 505, 507, 509, 511. Each of the insights 501, 503, 505, 507, 509, 511 may be an example of an insight generated by the insight module 222. In some examples, the user interface 500 is an example of an interface for engineering enterprise services, and the insights 501, 503, 505, 507, 509, 511 are examples of engineering insights for the persona of an engineer, software developer, or similar. In some examples, each insight of the plurality of insights 501, 503, 505, 507, 509, 511 are presented as a separate card that may be viewed collectively. In other examples, the plurality of insights 501, 503, 505, 507, 509, 511 may be presented individually as individual cards, such that when one insight is addressed, dismissed, etc. the next insight is presented.

The first insight 501 is an insight identifying actions that are assigned for incident workflow. The first insight 501 includes a summary of the insight, which is to review new or active incidents, a selectable icon to review incidents, and a selectable icon to view additional, or more, insights. As referenced herein, a selectable icon is an icon that may be selected on the user interface 500 that, when selected, causes the user interface to present an additional interface that includes information regarding the selected icon. For example, upon the selectable icon to review incidents being selected, an interface is presented that presents new or active incidents, as described in the summary. From there, the incidents may be viewed, selected, and so forth in order to be addressed. In some implementations, selecting a selectable icon may navigate the user interface 500 to an interface for a native integrated application 206 as described herein.

The second insight 503 is an insight identifying actions for incident repair items. The second insight 503 includes a summary of the insight, which is that the user has incident repair items with expiring service level agreements (SLA) this week, a selectable icon to email the report including the incident repair items, and a selectable icon to review repair items insights.

The third insight 505 is an insight identifying actions for postmortem analysis for resolved incidents. For example, actions for postmortem analysis for resolved incidents may be an action to review incidents that have previously been resolved for completion. The third insight 505 includes a summary of the insight, which is that the user has incident postmortem action items assigned to them to be reviewed, a selectable icon to review the items, and a selectable icon to review similar completed items, such as previous actions for postmortem analysis of resolved incidents that the user has completed.

The fourth insight 507 is an insight identifying action items for a particular code development application. The fourth insight 507 includes a summary of the insight, including two user stories assigned to the user and three action items linked to active or new tasks, a selectable icon to review the action items, and a selectable icon to view more insights.

The fifth insight 509 is an insight identifying updates and action items for a pull request. The fifth insight 509 includes a summary of the insight, including that a pull request has been signed off and the user is a required viewer on one pull request, a selectable icon to view pull request updates, and a selectable icon to review action items.

The sixth insight 511 is an insight identifying action items for service compliance. The sixth insight 511 includes a summary of the insight, including that there is one critical compliance action item with an SLA of less than twenty-four hours and three compliance actions due this week, a selectable icon to review the items, and a selectable icon to view more insights.

In some implementations, the cards indicating the insights 501, 503, 505, 507, 509, 511 may be presented together on the user interface 218. In other implementations, the cards indicating the insights 501, 503, 505, 507, 509, 511 may be grouped according to various criteria. For example, as shown in FIG. 5, the first insight 501, second insight 503, and third insight 505 are grouped together as ‘Top Incident Actions for your Services this week’ while the fourth insight 507, fifth insight 509, and sixth insight 511 are grouped together as ‘Top DevOps and Engineering Loop Action Items for your Services this week’. However, various examples are possible and the insights may be grouped in one of several ways without departing from the scope of the present disclosure. For example, insights may be grouped together such that action items are presented together, updates are presented together, and service compliance items are grouped together. In another example, insights may be grouped together by priority or time such that insights to be addressed within twenty-four hours are grouped together, insights to be addressed within the week are grouped together, and insights to be addressed within the month are grouped together.

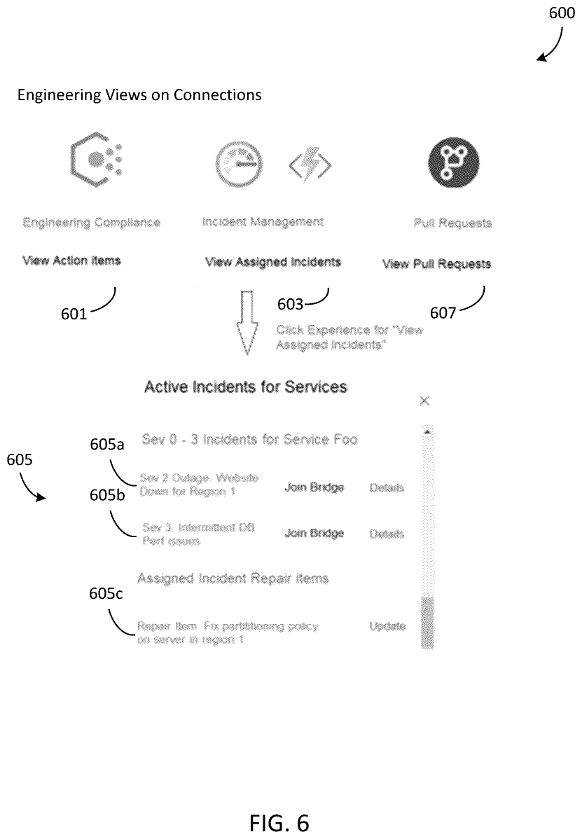

FIG. 6 illustrates an example productivity experience extension according to various examples of the present disclosure. The user interface 600 illustrated in FIG. 6 is presented for illustration only and should not be construed as limiting. Various examples of the user interface 600 may be implemented without departing from the scope of the present disclosure.

The user interface 600 is an example of an engineering-focused productivity experience. The user interface 600 illustrates action items 601, assigned incidents 603, and pull requests 607. Each of the action items 601, assigned incidents 603, and pull requests 607 may be examples of insights generated by the insights module 222 and are presented as selectable icons that, when selected, provide additional information regarding the selected icon. For example, FIG. 6 illustrates active incidents for service 605, presented in response to the selection of the assigned incidents 603. The incidents may be sorted by severity, by types of incident, and so forth. For example, the active incidents for service 605 includes a first incident 605a and a second incident 605b that are incidents for service having a severity level between 0 and 3, and a third incident 605c that is an assigned incident repair item.

The first incident 605a is a severity two outage for a website down for Region 1. The first incident 605a includes a selectable icon to join a bridge related to the incident and a selectable icon to view additional details regarding the incident. The active incidents for service 605 further includes the second incident 605b, which is a severity three issue related to intermittent database performance. The second incident 605b includes a selectable icon to join a bridge related to the incident and a selectable icon to view additional details regarding the incident. The severity level, such as two for the first incident 605a and a three for the second incident 605b, may indicate a priority for resolving the incident. For example, a severity level three may indicate a higher priority incident than an incident having a severity level two. The third incident 605c is a repair item to fix a partitioning policy on a server in region 1. The third incident 605c includes a selectable icon to update the repair item.

The user interface 600 may be an example of the user interface 218 described herein. Thus, selecting one or more of the selectable icons of the first incident 605a, second incident 605b, and/or third incident 605c may navigate the user interface 600 to a native integrated application experience of an application 206 integrated by the connection module 220. For example, as described herein, the connection module 220 integrates a native version of first- and third-party applications 206 to the user interface 218. The native version of the application 206 may be accessed via the selection of one or more of the selectable icons of the first incident 605a, second incident 605b, and/or third incident 605c.

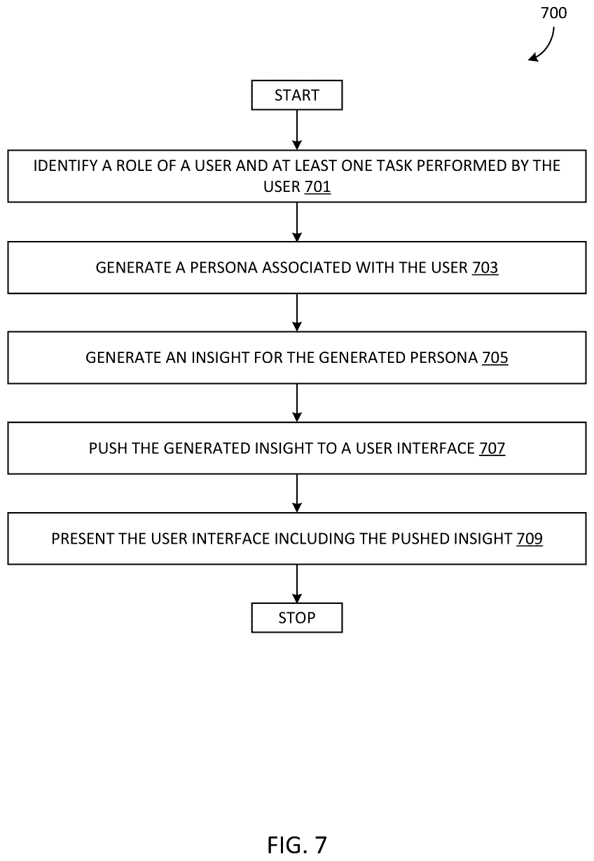

FIG. 7 is a flow chart illustrating a computer-implemented method of refreshing multiple monitors at independent refresh rates according to various examples of the present disclosure. The operations illustrated in FIG. 7 are for illustration and should not be construed as limiting. Various examples of the operations may be used without departing from the scope of the present disclosure. The operations of the flow chart 700 may be executed by one or more components of the system 200, including the processor 208, the connection module 220, the insights module 222, the learning module 224, the topics module 226, the ML module 228, and the persona generating module 230.

The flow chart 700 begins by identifying, by the persona generating module 230, a role of a user and at least one task performed by the user in operation 701. As described herein, the role of a user may include one or both of a title of the user and an experience level of the user. The task performed by the user include the type of task performed, details regarding the action the user took to perform the task, time stamps identifying when the user performed the task, and so forth. For example, the persona generating module 230 may implement the ML module 228 to identify whether at least one task has been performed by monitoring the graph that illustrates team memberships, product and service relationships such as services owned, and productivity and systems assignments for a particular user or persona. Upon identification of the change in status of the task to completed, the ML module 228 determines that the task has been performed by the user.

In operation 703, the persona generating module 230 generates a persona associated with the user based at least in part on the identified role of the user and the identified at least one task performed by the user. As described herein, the generated persona includes the identified role and common tasks performed by the particular user in the identified role.

In operation 705, the insights module 222 generates at least one insight for the generated persona. In some examples, the insight is a notification identifying one or more of an action item, a suggested action, or an update for the user associated with the generated persona. The insights module 222 may generate the insight by identifying an application accessed to perform the at least one task, identifying an update to the identified application, extracting data from the identified application based on the identified update, the data including one or more of the action item, the suggested action, or the update, and generating the insight based on the extracted data. In operation 707, the insights module 222 pushes the generated insight to the user interface 218. In operation 709, the processor 208 causes the user interface 218, including the pushed insight, to be presented on the display 216. In some examples, the user interface 218 is an engineering enterprise interface.

In some examples, the computer-implemented method further includes integrating, by the connection module 220, a native version of the identified application to the user interface 218. In some examples, the identified application is a first-party application or a third-party application.

In some examples, the computer-implemented method further includes identifying a theme associated with one or more of the identified role, the identified at least one task performed by the user, and an application accessed to perform the at least one task, identifying metadata associated with the identified theme, identifying learning-based content associated with the identified metadata, and presenting the identified learning-based content on the user interface.

In some examples, the computer-implemented method further includes identifying a topic associated with one or more of the identified role, the identified at least one task performed by the user, an application accessed to perform the at least one task, and additional users in an organization of the user, identifying content associated with the identified topic, and presenting the identified content on the user interface.

### ADDITIONAL EXAMPLES

Some examples herein are directed to a computer-implemented method of providing an improved user interface that presents integrated enterprise services, as illustrated by the flow chart 700. The computer-implemented method (700) includes identifying (701) a role of a user and at least one task performed by the user, generating (701) a persona associated with the user based at least in part on the identified role of the user and the identified at least one task performed by the user, generating (705) an insight for the generated persona, pushing (707) the generated insight to a user interface (218), and presenting (709) the user interface including the pushed insight.

In some examples, the generated insight is a notification identifying one or more of an action item, a suggested action, or an update for the user associated with the generated persona.

In some examples, the computer-implemented method further includes identifying an application (206) accessed to perform the at least one task and integrating a native version of the identified application to the user interface.

In some examples, generating the insight further includes identifying an update to the identified application, extracting data from the identified application based on the identified update, the data including one or more of the action item, the suggested action, or the update, and generating the insight based on the extracted data.

In some examples, the identified application is a first-party application or a third-party application.

In some examples, the computer-implemented method further includes identifying a theme associated with one or more of the identified role, the identified at least one task performed by the user, and an application accessed to perform the at least one task, identifying metadata associated with the identified theme, identifying learning-based content associated with the identified metadata, presenting the identified learning-based content on the user interface.

In some examples, the computer-implemented method further includes identifying a topic associated with one or more of the identified role, the identified at least one task performed by the user, an application accessed to perform the at least one task, and additional users in an organization of the user, identifying content associated with the identified topic, presenting the identified content on the user interface.

In some examples, the user interface is an engineering enterprise interface.

Although described in connection with an example computing device 100 and system 200, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, servers, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

What is claimed is:

1. A computer-implemented method, comprising:
identifying a role of a user and at least one task performed by the user;
generating a persona associated with the user based at least in part on the identified role of the user and the identified at least one task performed by the user;
generating an insight for the generated persona;
pushing the generated insight to a user interface; and
presenting the user interface including the pushed insight.

2. The computer-implemented method of claim 1, further comprising:
identifying an application accessed to perform the at least one task; and
integrating a native version of the identified application to the user interface.

3. The computer-implemented method of claim 2, wherein the generated insight is a notification identifying one or more of an action item, a suggested action, or an update for the user associated with the generated persona.

4. The computer-implemented method of claim 3, wherein generating the insight further comprises:
identifying an update to the identified application,
extracting data from the identified application based on the identified update, the data including one or more of the action item, the suggested action, or the update, and
generating the insight based on the extracted data.

5. The computer-implemented method of claim 3, wherein the identified application is a first-party application or a third-party application.

6. The computer-implemented method of claim 1, further comprising:
identifying a theme associated with one or more of the identified role, the identified at least one task performed by the user, and an application accessed to perform the at least one task;
identifying metadata associated with the identified theme;
identifying learning-based content associated with the identified metadata; and
presenting the identified learning-based content on the user interface.

7. The computer-implemented method of claim 1, further comprising:
identifying a topic associated with one or more of the identified role, the identified at least one task performed by the user, an application accessed to perform the at least one task, and additional users in an organization of the user;
identifying content associated with the identified topic; and
presenting the identified content on the user interface.

8. The computer-implemented method of claim 1, wherein the user interface is an engineering enterprise interface.

9. A system, comprising:
a memory storing instructions;
a processor configured to execute the instructions stored on the memory;
a user interface;
a persona generating module, implemented on the processor, configured to:
identify a role of a user and at least one task performed by the user, and
generate a persona associated with the user based at least in part on the identified role of the user and the identified at least one task performed by the user, and
an insights module, implemented on the processor, configured to generate an insight for the generated persona,
wherein the processor is further configured to present the user interface including the generated insight.

10. The system of claim 9, further comprising a connection module, implemented on the processor, configured to:
identify an application accessed to perform the at least one task; and
integrate a native version of the identified application to the user interface.

11. The system of claim 10, wherein the generated insight is a notification identifying one or more of an action item, a suggested action, or an update for the user associated with the generated persona.

12. The system of claim 11, wherein, to generate the insight, the insights module is further configured to:
identify an update to the identified application;
extract data from the identified application based on the identified update, the data including one or more of the action item, the suggested action, or the update, and
generate the insight based on the extracted data.

13. The system of claim 11, wherein the identified application is a first-party application or a third-party application.

14. The system of claim 9, further comprising a learning module, implemented on the processor, configured to:
identify a theme associated with one or more of the identified role, the identified at least one task performed by the user, and an application accessed to perform the at least one task;
identify metadata associated with the identified theme; and
identify learning-based content associated with the identified metadata,
wherein the processor is further configured to present the identified learning-based content on the user interface.

15. The system of claim 9, further comprising a topics module, implemented on the processor, configured to:
identify a topic associated with one or more of the identified role, the identified at least one task performed by the user, an application accessed to perform the at least one task, and additional users in an organization of the user; and
identify content associated with the identified topic,
wherein the processor is further configured to present the identified content on the user interface.

16. The system of claim 9, wherein the system is an engineering enterprise system.

17. One or more computer readable storage media storing instructions that, when executed by a processor, cause the processor to:
identify a role of a user and at least one task performed by the user;
generate a persona associated with the user based at least in part on the identified role of the user and the identified at least one task performed by the user;
generate an insight for the generated persona; and
present a user interface including the generated insight.

18. The one or more computer readable storage media of claim 17, further storing instructions that, when executed by the processor, further cause the processor to:
identify an application accessed to perform the at least one task; and
integrate a native version of the identified application to the user interface.

19. The one or more computer readable storage media of claim 18, wherein the generated insight is a notification identifying one or more of an action item, a suggested action, or an update for the user associated with the generated persona.

20. The one or more computer readable storage media of claim 19, further storing instructions that, when executed by the processor, further cause the processor to:
identify an update to the identified application;
extract data from the identified application based on the identified update, the data including one or more of the action item, the suggested action, or the update, and
generate the insight based on the extracted data.
